(19) United States
(12) Patent Application Publication
(10) Pub. No.: US 2005/0013416 A1
(43) Pub. Date: Jan. 20, 2005

(54) Telephone communication system with safety features

(76) Inventors: David E. Lee, Huntington, CT (US); Andrew Kontomerkos, Trumbull, CT (US)

Correspondence Address: BACHMAN & LAPOINTE, P.C., 900 CHAPEL STREET, SUITE 1201, NEW HAVEN, CT, 06510, US

(21) Appl. No.: 10/623,345

(22) Filed: Jul. 16, 2003

(51) Int. Cl. H04M 11/04

(52) U.S. Cl. 379/37; 379/45

(57) ABSTRACT

A telephone communication system includes a telephone device having a plurality of buttons, a memory and a processor; and a mechanism for storing a plurality of approved numbers in the memory associated with the button, the means being at least one of (1) remote from the telephone device, and (2) password protected; wherein the processor is adapted to allow outgoing calls to be placed by the telephone device only to the approved numbers.

### BACKGROUND OF THE INVENTION

The invention relates to a telephone communication system, and more particularly, to a communication system including safety features adapted to allow limited communication ability to certain individuals such as minors, to provide enhanced security to individuals in need thereof, and to provide enhanced emergency calling and monitoring ability.

Portable telephone devices such as cell phones and the like are in wide spread use. These devices are utilized for various different communication needs, including the needs of children, the elderly, infirm and the like. Unfortunately, it may not be desirable to provide a child with a cellular telephone or the like since parents or guardians of the child may not wish to provide the child with access to all types and manners of calls that can be placed using the telephone.

Conventional telephones can also be difficult to use for those who are infirm, or who have lost manual dexterity and the like. In such instances, the ability to remember and/or dial numerous different telephone numbers may be impaired.

It is clear that the need exists for an improved communications system which can be readily used by children, those who are infirm, and the like.

It is therefore the primary object of the present invention to provide such a communication system.

Other objects and advantages of the present invention will appear hereinbelow.

### SUMMARY OF THE INVENTION

In accordance with the present invention, the foregoing objects and advantages have been readily attained.

According to the invention, a telephone communication system is provided which comprises a telephone device having a plurality of buttons, a memory and a processor; and means for storing a plurality of approved numbers in said memory associated with said buttons, said means being at least one of (1) remote from said telephone device, and (2) password protected; wherein said processor is adapted to allow outgoing calls to be placed by said telephone device only to said approved numbers.

In further accordance with the invention, a telephone communication system is provided which comprises a telephone device having a plurality of buttons, a memory and a processor; means for storing a plurality of numbers in said memory associated with said buttons, at least one of said plurality of numbers being an emergency number and one of said buttons being a call end button; wherein said processor is adapted to disable said call end button when a call is placed to said emergency number.

### BRIEF DESCRIPTION OF THE DRAWING

A detailed description of preferred embodiments of the present invention follows, with reference to the attached drawings, wherein:

FIG. 1 illustrates a front view of a telephone device in accordance with the present invention;

FIG. 2 illustrates a rearview of the device in accordance with the present invention; and

FIG. 3 illustrates a side view in accordance with the present invention.

### DETAILED DESCRIPTION

The invention relates to a telephone communication system which is adapted to provide limited and controlled dialing ability which is suitable for children, which is further adapted to allow calls to be placed pressing a single button, which is particularly useful to both children and the infirm or those who have impaired manual dexterity, and further has enhanced safety features including single button emergency or safety calling, call locking once a call is placed to an emergency service, global positioning satellite (GPS) functionality to allow location of the user, for example upon placement of an emergency call, and other features.

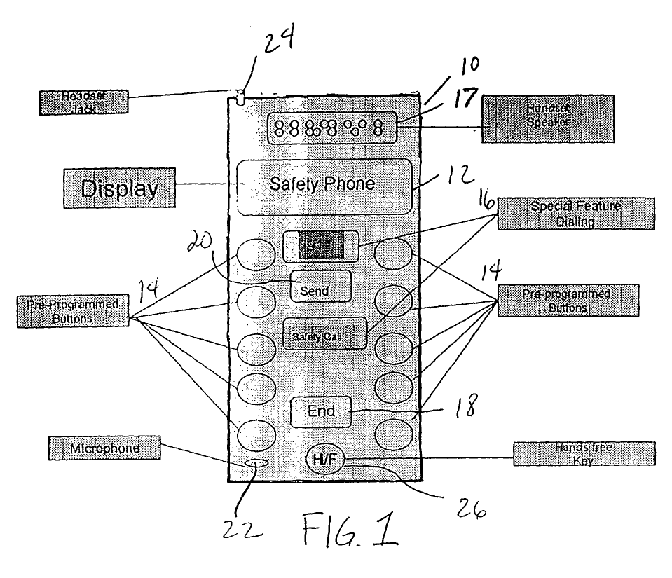

FIGS. 1-3 illustrate the exterior features of a telephone device which is useful in the system of the present invention. These exterior features will be described below, as will be the function of the system.

FIG. 1 shows a telephone device 10 having a display 12, a plurality of pre-programmable buttons 14, a plurality, in this embodiment two, special feature buttons 16, a handset speaker 17, an end button 18, a send button 20, a microphone 22 and a headset jack 24. Many of these features have well known functions which will be readily apparent to one of ordinary skill in the art. The key features of the present invention are pre-programmable buttons 14 which are preferably provided having different shapes or distinguishable contours whereby they can be distinguished from each other by feel, and which, as will be further discussed below, are associated with a restricted number of pre-programmed and approved numbers which can be called utilizing device 10.

Additionally, and in some instances more importantly, special feature buttons 16 are also distinguishable by different shape and/or contour or the like whereby an individual can readily and rapidly locate the button of device 10 which is used to call an emergency service, without necessarily being able to see the device.

In accordance with a further aspect of the present invention, device 10 is provided with hands free operation, and a hands free button of key 26 can be provided for enabling and disabling this function.

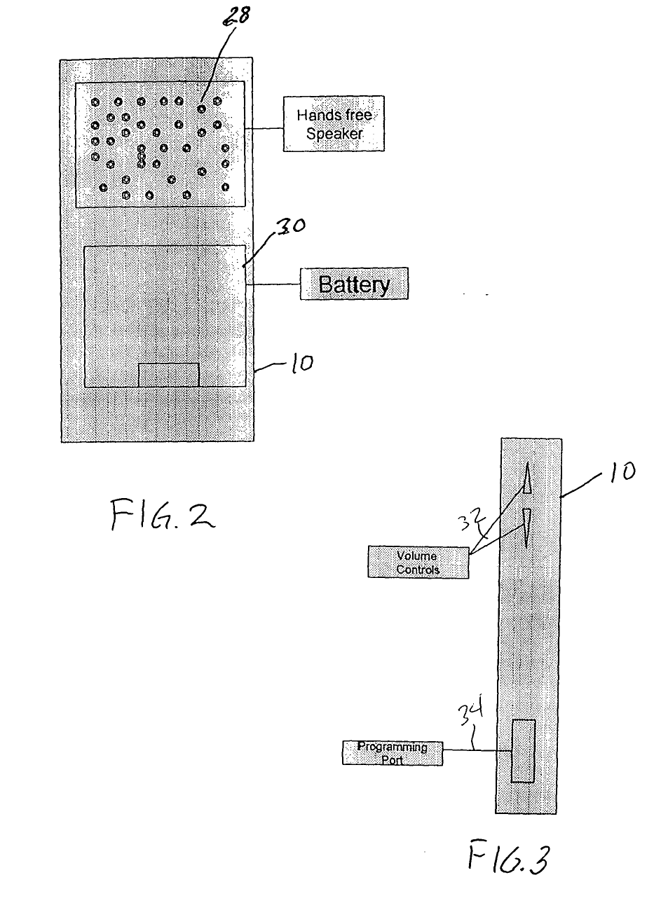

Turning to FIGS. 2 and 3, a rear surface of device 10 can be provided having a hands free speaker 28 as shown, along with a typical battery compartment 30. From FIG. 3, it can be seen that the side portion of device 10 can be provided having volume controls 32 as well as a programming port 34 which can advantageously be used for pre-programming of desired numbers to be associated with buttons 14, 16 as indicated above.

Internally of device 10, the device is provided including a typical storage member or memory which can advantageously be used to store a plurality of approved numbers in a memory of the device. These approved numbers are stored and associated with a particular button 14, 16, whereby depressing or otherwise interaction of a single key or button can be utilized to rapidly and easily call a pre-approved number.

In further accordance with the invention, the programming function of device 10 is advantageously restricted such that minors or children and the like cannot access device 10 to dial, call or otherwise make calls to numbers that have not already been approved by a parent or guardian. This functionality can be accomplished through several methods, including utilizing a remote programming device, for example a personal computer, which is maintained under control by the guardian or parent, and which can be used as the only method for storing approved numbers for calling in device 10.

Alternatively, device 10 can be provided to allow for entry of numbers into the memory, for example with a password protected function.

In further accordance with the invention, a processor is also provided within device 10 and this processor is programmed and adapted to provide for the desired functionality of device 10. Thus, the processor is advantageously adapted to allow outgoing calls to be placed by the telephone device 10 only to the numbers which are stored in the memory, that it is the approved numbers, which are associated with the buttons on the telephone.

In further accordance with the invention, device 10 and processor incorporated therein can further advantageously be adapted to allow incoming calls only from approved numbers as well. This can of course be accomplished in a number of ways, typically utilizing well known caller ID functionality to compare the source of the incoming call to the approved numbers list.

In further accordance with the invention, the processor can be adapted and programmed to limit duration of calls made using device 10, and this may be a particularly desirable feature for devices 10 to be provided to minors. Further, this feature can be programmable using the restricted access programming function of the invention such that duration of the call can be limited on specific numbers, or can be placed on use of device 10 overall.

The special feature buttons 16, which can for example include an E911 as well as one other emergency call function, are also programmed into device 10. The E911 functionality may advantageously be hard-wired into device 10, rather than programmed using the remote programming method of the present invention.

Buttons 16 are advantageously of a different shape and/or contour from each other, and especially from buttons 14, such that an E911 or other emergency type of call can be placed rapidly by a user who can locate the button by feel.

In further accordance with the invention, the display 12 of device 10 can be utilized for displaying a current number to which the telephone is linked, or other various displays associated with normal utilization of a device such as device 10.

Speakers 16 and microphone 22 can advantageously be provided utilizing known components, the selection and programming of which would be well known to a person of ordinary skill in the art. In addition, it may be desirable to provide hands free operation of device 10, for example utilizing hands free key 26 and hands free speaker 28 whereby device 10, when used in locations where it is not convenient to hold the device, can nevertheless provide the desired function.

In further accordance with the invention, a call lock feature is built-into emergency calls placed using device 10. This is advantageously provided through programming of the processor of device 10 whereby, once a call is placed to an emergency number, the end key 18, or its function, is disabled. Thus, once a call is placed for example to an emergency E911 number, device 10 cannot be used by itself to terminate the call. Advantageously, device 10 is programmed to monitor for termination of the call by the emergency authority or other party to the call, and at this time end key 18 is enabled to allow device 10 to also end the call.

In this regard, although the end key 18 is referred to as having been, or having its function, disabled and enabled as set forth above, it should of course be noted that this could be provided in a number of ways. Further, it is possible for an end command to be stored but not acted upon, after key 18 is depressed, but nevertheless such command can automatically be acted upon once termination of the emergency call by the other party is recognized by device 10.

In further accordance with invention, the processor is adapted to monitor for loss of signal during an emergency call and, in the event of such loss of signal, device 10 is advantageously adapted to periodically recall the number and attempt to reestablish communication with the emergency authority.

In connection with various functions of the device, and most preferably in connection with the emergency call feature, it may be desirable to associate speaker and microphone volume and sensitivity control with the processor such that the processor controls either speaker volume or microphone sensitivity to desired levels upon dialing of certain numbers. For example, during an emergency call, it may be desirable to reduce speaker volume and increase microphone sensitivity whereby monitoring of the location can be accomplished and communications back through to the telephone are more discreet. On the other hand, in connection with elderly, infirm or others who, for example, may have impaired hearing, it may be desirable to increase speaker volume upon dialing of an emergency. These functions can likewise be programmed into the processor using the restricted access programming of the present invention.

In further accordance with the invention, and as mentioned above, it may be desirable to incorporate global positioning satellite (GPS) functionality into device 10. In this manner, device 10 can determine its location, or can obtain information which can be used to determine its location, which information can be transmitted to an authorized user under desired circumstance. For example, this feature can be activated upon dialing of an emergency call whereby the emergency authority will be provided with position of device 10 on a periodic basis, for example every 15 seconds.

In further accordance with the invention, device 10 can advantageously be adapted to automatically answer a call from a particular authorized number such as a monitoring station and the like, and further can be adapted to recognize either a number, or a portion of a number which switches device 10 into a passive monitoring mode. In this mode, device 10 will answer the call without a ring, and further without any exterior visible indication that the call has been received, and will advantageously increase microphone sensitivity to maximum, reduce earpiece/speaker volume, and activate a GPS feature if present on the device, whereby location and activity at the location of device 10 can be monitored.

It should readily be appreciated that the system of the present invention provides for improved functionality to numerous and various different classes of users. For children and those in the care of parents and guardians, the system of the present invention can be used to provide communication ability in a controlled manner to such individuals. In this class of users, the device can also be used to provide enhanced security of emergency communications and the like, thereby allowing parents and guardians to trust that persons in their care can reliably place emergency calls if needed.

In connection with use by elderly and infirm or otherwise physically impaired individuals, easily placed calls are readily available to emergency personnel such as medical staff and the like, along with features designed to enhance communication ability, for example with hearing impaired individuals and the like.

Still further, in either mode, the GPS locating system is incorporated into emergency call features such that the location of a child or a potentially disoriented individual can be determined.

Still further, the shape and/or contour of buttons, along with reduced number thereof, makes use of the device in accordance with the present invention more readily accomplished by minors, infirm and like individuals.

It should readily be appreciated that the system of the present invention has therefore provided substantial advantages as set forth above.

It is to be understood that the invention is not limited to the illustrations described and shown herein, which are deemed to be merely illustrative of the best modes of carrying out the invention, and which are susceptible of modification of form, size, and arrangement of parts and details of operation. The invention rather is intended to encompass all such modifications which are within its spirit and scope as defined by the claims.

1. A telephone communication system, comprising:
a telephone device having a plurality of buttons, a memory and a processor;
means for storing a plurality of approved numbers in said memory associated with said buttons, said means being at least one of (1) remote from said telephone device, and (2) password protected;
wherein said processor is adapted to allow outgoing calls to be placed by said telephone device only to said approved numbers.

2. The system of claim 1, wherein said means for storing is further adapted to store a plurality of approved incoming numbers, and said processor is adapted to allow incoming calls only from said approved incoming numbers.

3. The system of claim 1, wherein said processor is further-adapted to limit duration of calls using said-telephone device.

4. The system of claim 1, wherein said plurality of buttons include a plurality of preprogrammed buttons for association with said approved numbers, and at least one special function button for association with emergency or safety authorities.

5. The system of claim 1, wherein said telephone device further includes a microphone and a speaker, and wherein said processor is adapted to control at least one of speaker volume and microphone sensitivity when pre-selected calls are made.

6. The system of claim 5, wherein said processor is further adapted to recognize a passive-mode triggering number, and upon receiving a call from said number is adapted to receive said call with no audible or visible signal, to increase microphone sensitivity and to reduce said speaker volume.

7. The system of claim 1, wherein said telephone device further comprises means for communicating with a global positioning satellite (GPS) system, and wherein said processor is further adapted to communicate GPS information to a pre-approved entity upon at least one of (1) dialing a pre-selected number and (2) receiving a call from a pre-selected number.

8. The system of claim 7, wherein said telephone device further includes a monitor number in said memory and wherein said processor is adapted to answer a call from said monitor number without generating an audible signal and for transmitting said GPS information to said pre-approved entity.

9. The system of claim 1, wherein said plurality of buttons are of different shapes whereby said buttons can be distinguished from each other by feel.

10. A telephone communication system, comprising:
a telephone device having a plurality of buttons, a memory and a processor;
means for storing a plurality of numbers in said memory associated with said buttons, at least one of said plurality of numbers being an emergency number and one of said buttons being a call end button;
wherein said processor is adapted to disable said call end button when a call is placed to said emergency number.

11. The system of claim 10, wherein said processor is further adapted to enable said call end button upon other party termination of said call to said emergency number.

12. The system of claim 10 wherein said processor is further adapted to recall said emergency number upon loss of signal by said telephone device.

13. The system of claim 10, wherein said telephone device further includes a microphone and a speaker, and wherein said processor is adapted to control at least one of speaker volume and microphone sensitivity when pre-selected calls are made.

14. The system of claim 10, wherein said plurality of buttons are of different shapes whereby said buttons can be distinguished from each other by feel.
